(19) United States
(12) Patent Application Publication
(10) Pub. No.: US 2012/0226602 A1
(43) Pub. Date: Sep. 6, 2012

(54) Online Marketplace for Content Licensing Using Geopositional Data

(76) Inventors: Allen Narcisse, Sherman Oaks, CA (US); William Momary, Sherman Oaks, CA (US)

(21) Appl. No.: 13/408,712

(22) Filed: Feb. 29, 2012

Related U.S. Application Data
(60) Provisional application No. 61/447,940, filed on Mar. 1, 2011.

(51) Int. Cl. G06F 15/16; G06Q 20/22; G06F 3/048

(52) U.S. Cl. 705/39; 709/204; 709/206

(57) ABSTRACT

Systems, methods, and computer program products for facilitating an online marketplace portal that enables content publishers and content creators to integrate geopositional considerations into their process for identifying licensing partners are disclosed. In an embodiment, such online marketplace portal allows users to consider geopositional data associated with content and content pitch proposals. Users may also consider geopositional data associated with other users when vetting and selecting possible licensing partners. Then, users may further use such online marketplace portal to propose and consummate content licensing arrangements with other users.

### CROSS REFERENCE TO RELATED APPLICATIONS

This Application claims priority to pending U.S. Provisional Patent Application No. 61/447,940 (Attorney Docket No. EBY.02), titled “Online Marketplace Portal for Content Creation and Licensing Using Geopositional Data,” filed on Mar. 1, 2011, which is hereby incorporated by reference as to its entire contents.

This Application is also related to pending U.S. patent application Ser. No. 13/049,434 (Attorney Docket No. EBY.03), titled “Online Marketplace Portal for Content Publishers and Content Creators,” filed on Mar. 16, 2011, which is hereby incorporated by reference as to its entire contents.

### FIELD OF THE INVENTION

The present disclosure generally relates to media marketplaces and more particularly to systems, methods, and computer program products for facilitating the navigation of information used to enter into content licensing agreements.

### BACKGROUND

With the advent of new technology, the media marketplace is growing in licensor networks and licensees of various contents (i.e., written articles, photography, creative art, music, audio, multimedia, and video). That is, periodical publishers and content providers frequently license content from a broad network of content creators (e.g., independent contractor freelance contributors, syndicated content services, publishing company employees, and other creators). Conversely, content creators both proactively submit and license out their content to a variety of publishers, content providers, and other licensees, and generate custom content according to the specifications of a specific licensor's request. Publishers and creators navigate this extensive network of licensees and licensors in order to identify licensing partners using a variety of factors (e.g., history of performance, industry reputation, and cost).

Publishers and content providers may also often desire to license content associated with a specific geoposition. News publishers, for example, may want to provide news coverage for a certain metropolitan area (or a specific neighborhood within that metropolitan area). Such publishers may also be interested in receiving content pitch proposals from third-party content creators relating to a specific geoposition and upcoming events in a specific geoposition (e.g., sporting event, trade show, or political rally). Publishers may also—in the case of an unexpected breaking news event occurring at a specific geoposition—want to quickly assign content creators to generate associated content, and later may want to license additional background content associated with that geoposition.

In these scenarios, publishers desire to consider the relative geoposition of available content creators and licensors as a factor in selecting a licensing partner. For example, a freelance reporter with a relatively weak reputation may still be valuable to a publisher if the reporter happens to be closer to the site of a breaking news event. Publishers seeking to license content associated with a particular neighborhood may also desire to license content from content creators living or currently located in or near that neighborhood.

Publishers often maintain a database of addresses for the freelancers they have worked with in the past; however, they may not easily verify a specific freelancer's location at a given moment and gather information about previously-unused freelancers at or near a specific geoposition. Additionally, publishers currently have to spend time and resources sifting, tagging and/or sorting through such content proposals to identify those which are relevant to their desired geographic region of focus, lacking the ability to integrate geopositional considerations when licensing content from other publishers. For example, one publisher may be able to fill a need for content relevant to a specific geographic region by licensing content from another publisher; however, they may not pitch and/or receive such licensing opportunities based on geopositional data.

### SUMMARY

This summary is provided to introduce a selection of concepts. These concepts are further described below in the Detailed Description section. This summary is not intended to identify key features or essential features of the claimed subject matter, nor is this summary intended as an aid in determining the scope of the claimed subject matter.

Embodiments of the present disclosure meet the above-identified needs by providing systems, methods, and computer program products that allow content editors to view geopositional information related to content creators for the purpose of commissioning content creation, assigning work, tracking work, viewing past trends, making decisions about which content creators to engage, and other tasks related to managing content creation. Such systems, methods, and computer program products include a computer implemented online marketplace portal facilitating at least one creator and at least one editor coming together to enter into a licensing agreement based on information about such creators or editors (e.g., geolocation, profile information, etc.).

Further features and advantages of the present disclosure, as well as the structure and operation of various aspects of the present disclosure, are described in detail below with reference to the accompanying drawings.

### BRIEF DESCRIPTION OF THE DRAWINGS

The features and advantages of the present disclosure will become more apparent from the detailed description set forth below when taken in conjunction with the drawings in which like reference numbers indicate identical or functionally similar elements.

FIG. 1 is a block diagram illustrating an online marketplace portal for content creation and licensing using geopositional data according to an embodiment of the present disclosure.

FIG. 2 is a flowchart illustrating a process by which publishers may use the relative geoposition of various content creators as a criterion to identify and select content licensing partners according to an embodiment of the present disclosure.

FIG. 3 is a depiction of a display generated by the marketplace portal allowing publishers to view information about multiple creators according to an embodiment of the present disclosure.

FIG. 4 is a flow chart illustrating a process by which publishers may identify and select content or content pitch proposals based on their geoposition according to an embodiment of the present disclosure.

FIG. 5 is a depiction of a display generated by the marketplace portal allowing publishers to view licensable content and content pitch proposals sorted according to geoposition according to an embodiment of the present disclosure.

FIG. 6 is a flow chart illustrating a process by which publishers may use the geoposition of various events for which content is desired as a means for identifying and partnering with content creators according to an embodiment of the present disclosure.

FIG. 7 is a depiction of a display generated by the marketplace portal allowing publishers to view licensable content and content pitch proposals sorted accorded to their association with scheduled and breaking news events according to an embodiment of the present disclosure.

FIG. 8 is a block diagram of an example computing device that may be configured to implement one or more embodiments of the present disclosure.

FIGS. 9-13 are screenshots of editor views according to various embodiments of the present disclosure.

FIGS. 14-17 are screenshots of content creator (freelancer) views of according to various embodiments of the present disclosure.

FIGS. 18-19 are screenshots of map search input and compare tools according to various embodiments of the present disclosure.

### DETAILED DESCRIPTION

The present disclosure is directed to systems, methods, and computer program products for facilitating an online marketplace portal for content creation and licensing using geopositional data.

In one embodiment, the present disclosure provides a solution based on navigation of information by which to enter into a license agreement. In such an embodiment, content creators connect to a portal remotely (i.e. via the Internet, mobile connectivity, or some other means) to indicate their geoposition in (near) real time. Publishers then use the portal to view the current geoposition of various content creators, and determine such creators' relative proximity to specific locations (e.g., buildings, landmarks, neighborhoods, cross streets, zip codes, etc.), scheduled events (e.g., concerts, trade shows, etc.), and/or breaking news events.

In an embodiment, publishers viewing a display of content creators sorted by geoposition may review each content creator's profile, send messages, and propose and consummate content licensing arrangements. Marketplace portal 102 may additionally allow editors 108 to track events in (near) real time with input such as police notifications, fire alarms, and public event listings. In such an embodiment, an editor 108 may select to cover an event. The editor 108 then links to an assignment page, where assignments are prepopulated with the event date and description (e.g., assignment description text and title). In an embodiment, such events may be fed into portal 102 from a commercial event publisher service (e.g., the Zvents.com service available from Zvents, Inc. of San Mateo, Calif., the Eventful.com service available from Eventful, Inc. of San Diego, Calif., the Upcoming.org service available from Yahoo!, Inc. of Santa Clara, Calif., or other similar services). Editors 108 may then view upcoming events geographically, sort events by category and date, and assign favorite freelancers 110 to specific events. The marketplace portal 102 may also allow publishers 108 to use geopositional data and relative proximity information—either as a hard filter or as a ranking factor—when ranking content creators 110 as possible candidates for a licensing opportunity.

In an embodiment, the present disclosure provides a mobile device-enabled application or other software which allows users to communicate with an ASP providing marketplace portal 102, perform certain functions remotely, and to be located remotely from the ASP. In such an embodiment, a user may sign in and be located by the server. Users may register or sign using various states (e.g., available for work, allow location to be seen or enter a different specific location, and at location but not available for work). Such states include “off-the-clock” mode which allows editors to see where freelancers are in the event of emergency (e.g., freelancer prefers not to work but has agreed to be contacted in the case of urgency). In an embodiment, various status indicators are available, including working on a story at present, indicator of progress on the current assignment, equipped with multimedia tools or other equipment, and credentials (i.e., press passes, licenses, special access/permits, etc.). The user may then send media (text, video, photos, and files) from the application to the server in the appropriate format for intake to the content management system.

In another embodiment, known events are published based on the incoming stream of future public events. With permission, freelancers 110 may access this published set of events and rely or pitch the coverage of such events. Such a pitch may include the title, dateline, category, story idea, availability, story type, fee, kill fee, deadline, preview, and send pitch or cancel.

In another embodiment, the present disclosure provides a licensing related informational navigation solution based on publishers 108 viewing content available for license as well as content pitch proposals in an integrated array or map sorted by geoposition. Such integrated array may include content from a variety of sources, including licensable content from third party publishers as well as freelance content creators. In such an embodiment, publishers 108 may sort the array using a variety of criteria including creator type (e.g., freelance content creator vs. publisher), date of creation, content type, media type (e.g., text, video, Flash animation, audio, etc.), and other metadata.

In yet another embodiment, the present disclosure provides a licensing related informational navigation solution based on publishers and creators furnished with an up to date list of “tagged” events—both scheduled events and breaking news events—including associated geoposition and other relevant metadata for each event. Such “tagged” events may come from a variety of sources, including publishers 108 and creators 110 themselves, third party content fields (e.g., digital services and other sources), among others. In such an embodiment, publishers 108 and creators 110 may view tagged events and their associated metadata in various arrays (i.e., maps, lists, and other sortable display formats). Content creators 110 may then use marketplace portal 102 to submit content pitch proposals associated with “tagged” events, and publishers 108 may rank and select content creators 110 for content licensing opportunities relating to tagged events.

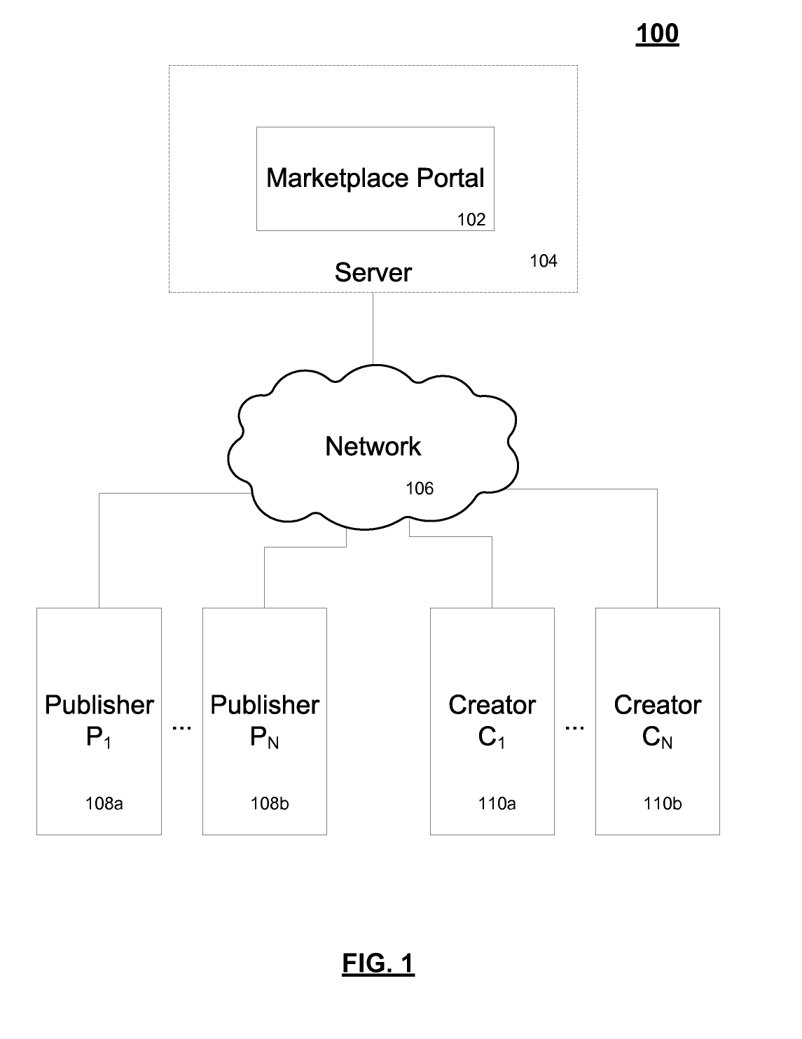

Referring now to FIG. 1, a block diagram is shown that illustrates an online marketplace portal environment 100 for content creation and licensing using geopositional data, according to an embodiment of the present disclosure. As is well known to those skilled in the relevant art(s), a marketplace portal 102 application may reside and execute on a server 104 executing within environment 100. One or more content publishers 108 (shown as publishers 108a-b), and one or more multiple content creators 110 (shown as creators 110a-b) connect to marketplace portal 102 via network 106. In an embodiment, network 106 is the global, public Internet, and publishers 108 and creators 110 may connect to marketplace portal 102 through a variety of computing devices and graphical user interfaces. Creators 110 may send their geoposition to marketplace portal 102 (either proactively or passively via a locator based application on a mobile device or other global positioning software (GPS) indicator). Publishers 108 and creators 110 may also communicate with each other using marketplace portal 102 via an internal messaging system (e.g., instant message (IM), chat or other online screen alert), or via standard means (e.g., e-mail, SMS, MMS, voice call or other form of telecommunication) initiated or facilitated by portal 102.

As will be appreciated by those skilled in the relevant art(s) after reading the description herein, in such an embodiment, a service provider—an individual, person, business, or automated system who may be providing a good or service—may allow users 108-110 to access infrastructure 100 on a free registration, paid subscriber and/or pay-per-use basis via one or more World-Wide Web (WWW) sites on Internet 106. Thus, environment 100 is scalable such that publishers 108, creators 110 and other personnel (collectively, “users”) from one or more organizations' may utilize it to facilitate an online marketplace for content creation and licensing using geopositional data.

As will also be appreciated by those skilled in the relevant art(s), in an aspect, various (login, admin, account, information, resource, logout, payment, registration, communications, etc.) screens would be generated by portal 102 in response to input from users 108-110 over Internet 106. That is, in such an embodiment, server 104 is a typical Web server running a server (i.e., portal 102) application at a Web site which sends out Web pages in response to Hypertext Transfer Protocol (HTTP) or Hypertext Transfer Protocol Secured (HTTPS) requests from remote browsers on various devices being used by various users 108-110. Thus, server 104 is able to provide a graphical user interface (GUI) to users of portal 102 in the form of Web pages. These Web pages are sent to one or more desktop (PC), laptop, tablet, notebook, mobile device, PDA, smart phone or like computing devices utilized by users 108-110, and would result in the GUI being displayed. Further, all users 108-110 account information described herein may be stored in one or more databases (not shown in FIG. 1) that are accessible by marketplace portal 102. In an alternate embodiment, the various data used by portal 102 can be stored in one or more memory included in (or coupled to) server 104.

As will also be appreciated by those skilled in the relevant art(s) after reading the description herein, alternate aspects of the present disclosure may include providing the tool for facilitating an online marketplace for content creation and licensing using geopositional data as a stand-alone system (e.g., installed on one server PC) or as an enterprise system wherein all the components of infrastructure 100 are connected and communicate via an inter-corporate wide area network (WAN) or local area network (LAN)—for example, in an embodiment where publishers 108 and content creators 110 are all personnel/employees of the same media/publishing company, rather than as a Web service (i.e., application service provider (ASP) model utilized by various users from different media/publishing companies) as shown in FIG. 1.

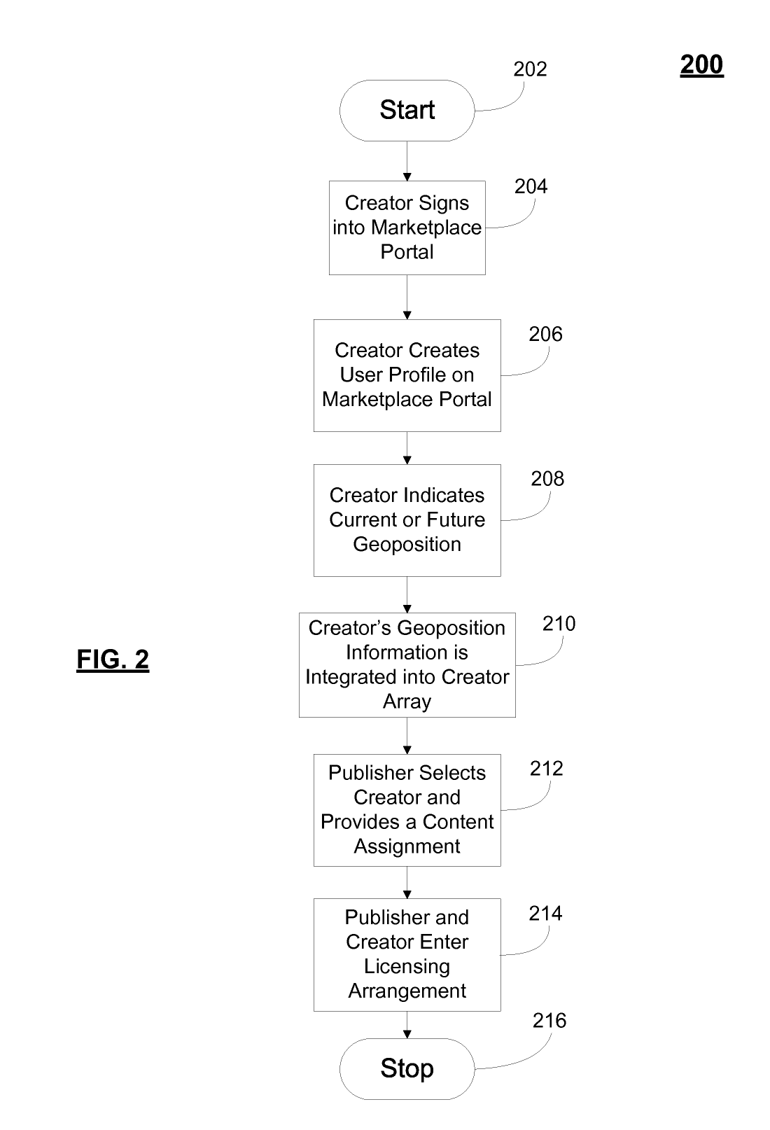

Referring now to FIG. 2, a flow chart illustrating a content creator identification and selection process 200, according to an embodiment of the present disclosure, is shown. Process 200, which would execute within environment 100, facilitates a publishers' use of the relative geoposition of various content creators 110 as a criterion to identify and select content licensing partners, begins at step 202 with control passing immediately to step 204.

In step 204, each creator 110 executing within environment 100 commences their participation by signing into marketplace portal 102. In such embodiment, creators 110 connect to marketplace portal 102 via a secure, encrypted connection. In step 206, each creator 110 creates a user profile on marketplace portal 102. In such embodiment, each creator's user profile includes information considered relevant to publishers interested in possible content licensing arrangements (i.e., professional contact information, a general overview of content areas of expertise, a list of content formats available, a catalogue of content available for license, content pitch proposals, suggested licensing terms and compensation structures, and selected references from previous content licensing partners). Further, in such an embodiment, marketplace portal 102 tags and organizes the data in each creator's profile into a database searchable and sortable by participating publishers.

In step 208, each creator 110 submits their geoposition in to marketplace portal 102. In one embodiment, creators 110 may manually input their geoposition into marketplace portal 102 via an online interface. In another embodiment, creators 110 may use a location-based service (e.g., an application on a GPS enabled mobile device) to update their geoposition in real time. In yet another embodiment, creators 110 may provide their anticipated future geoposition in addition to, or in lieu of, their present geoposition. For example, a creator 110 may indicate their plans to attend a particular event on a particular future date (e.g., “I will attend the XYZ trade conference in London next month”). Alternatively, a creator 110 may indicate their plans to be in a specific geographic region for an extended period of time (e.g., “I will be in San Francisco for two weeks in August”).

Next, in step 210, marketplace portal 102 integrates geoposition information about each creator 110 into a creator array for display to participating publishers. In an embodiment, marketplace portal 102 is capable of creating a geographic map indicating the locations of multiple creators for display to users' computing devices. In another embodiment, marketplace portal 102 is capable of creating a sortable table for display to users' computing devices. In yet another embodiment, publishers 108 are able to use various search queries to identify subsets of available creators based on geopositional relevant search terms (e.g., country, city, zip code, cross streets, proximity to landmarks, proximity to geographic coordinates, or time zone). In an embodiment, publishers 108 are able to search, sort, and filter the database of creators based on multiple factors, including geopositional data.

In step 212, a publisher 108 selects a creator from the pool of available creators 110 and submits a content assignment to that creator 110. In such embodiment, a content assignment comprises an offer to a content creator 110 to generate content to be licensed by publisher 108. In an embodiment, a publisher 108 uses marketplace portal 102 to submit the assignment to a creator 110, complete with the proposed terms and conditions associated with the license opportunity (i.e., the length, scope, exclusivity, compensation, etc. associated with licensing the content). In another embodiment, publisher 108 uses marketplace portal 102 to identify and select a content creator 110, and negotiates the terms and conditions of the content assignment (i.e., the scope, exclusivity, compensation, deadlines, etc. associated with creating and licensing the content) with the selected creator in an offline manner (i.e., not through online environment 100).

In step 214, portal 102 facilitates communications between publisher 108 and creator 110 so that they may agree to and enter into a licensing arrangement. In an embodiment, marketplace portal 102 also includes functionality to process and track delivery of the licensed content, updates and edits to the licensed content, and payments to creator 110 as consideration for granting any licenses.

Process 200, which facilitates publishers' use of the relative geoposition of various content creators as a criterion to identify and select content licensing partners on marketplace portal 102, then terminates as indicated by step 216.

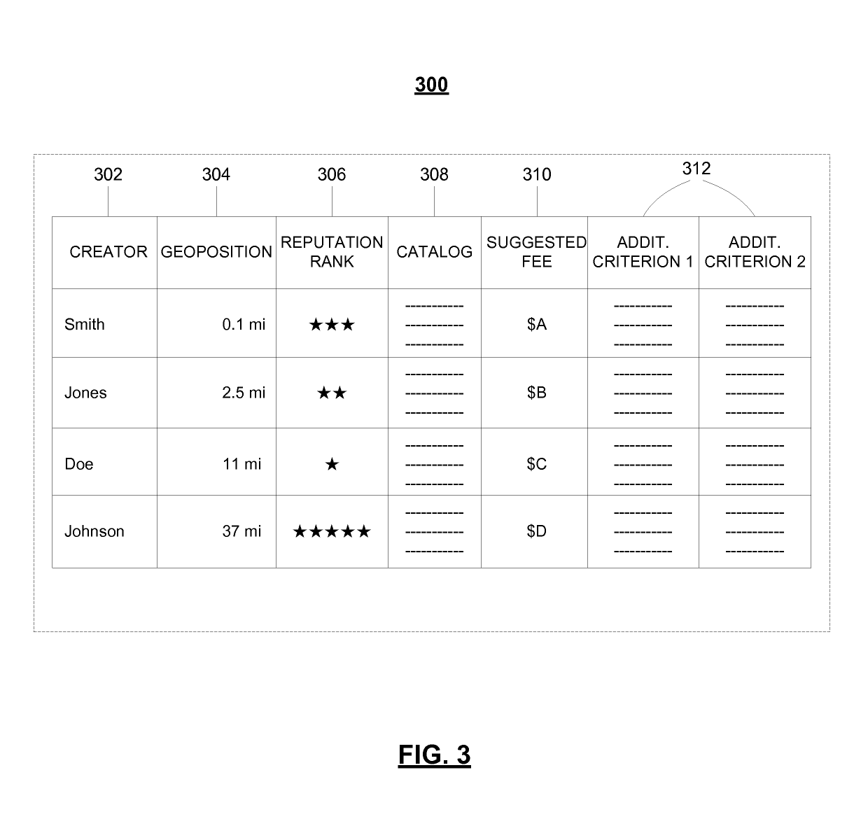

Referring to FIG. 3, a creator array 300 generated by marketplace portal 102 (step 210) based on a search query submitted by a publisher 108, according to an embodiment of the present disclosure, is shown. In such an embodiment, creator array 300 displays a first column 302 comprised of links to various creator profiles. In such embodiment, a second column 304 displays the relative geoposition of each creator 110, based on their distance from a location specified by publisher 108. In another embodiment, creator array 300 may instead display creator geoposition using other familiar location indicators (e.g., cross street, zip code, city, state, province, country, etc.).

In an embodiment, creator array 300 displays a third column 306 displaying each creator's “reputation rank.” In this embodiment, publishers 108 are afforded an opportunity to provide feedback (i.e., reviews) about a creator's services at the conclusion of a licensing arrangement. Marketplace portal 102 aggregates all feedback information received from publishers 108 into a reputation rank score (e.g., one-five stars, 1.0-10 scaled score, etc.), thereby providing future potential publishers 108 with review data about a creator's prior dealings in the marketplace portal.

Creator array 300 contains a fourth column 308 with links to each creator's catalog of contents available for license. In another embodiment, creator array 300 may display links to a creator's previously-licensed content as well. Creator array 300 further displays a fifth column 310 with each creator's suggested license fees for each piece of content within their catalog, or other key relevant licensing terms. Creator array 300 may be expanded to include one or more additional columns 312, each displaying an additional criterion relevant to identifying and selecting creators for licensing arrangements.

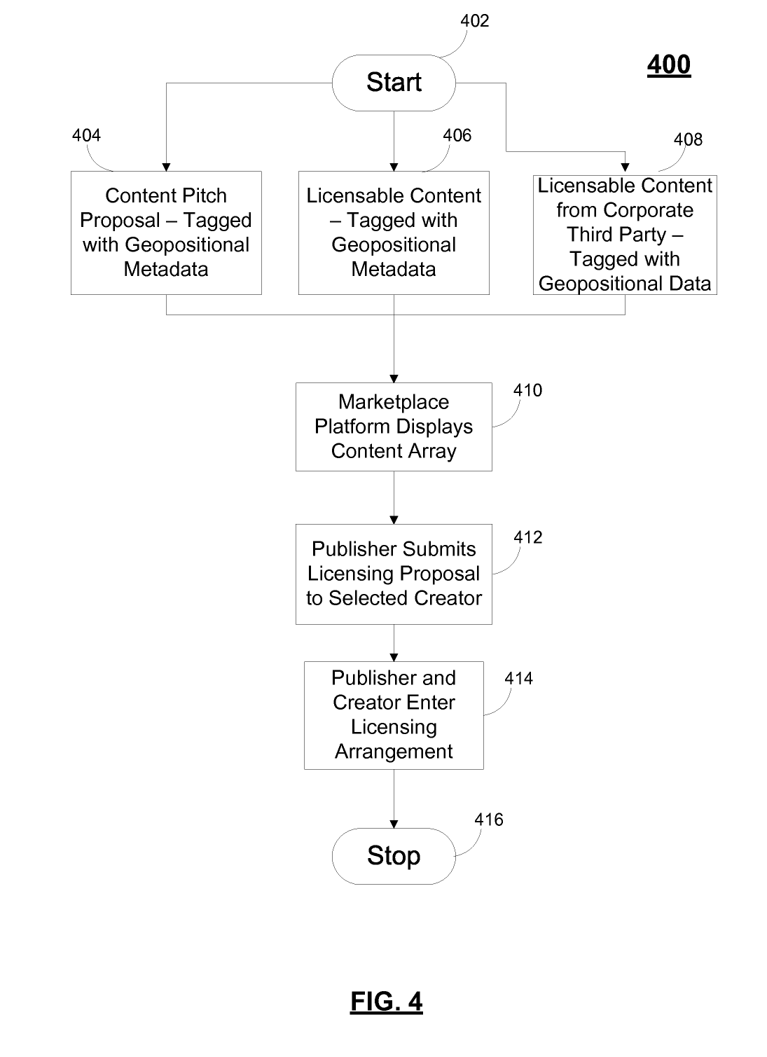

Referring now to FIG. 4, a content/content pitch proposal identification and selection process 400, according to an embodiment of the present disclosure, is shown. Process 400, which would execute within environment 100 and facilitate publishers identifying and selecting content or content pitch proposals based on their geoposition, begins at step 402 with control passing immediately to steps 404-408.

Marketplace portal 102 starts with tagging content pitch proposals (step 404), licensable content from participating creators (step 406), and licensable content from third-party publishers, news services, syndicates, and other corporate entities (step 408) with geopositional data. Each content or content pitch proposal available for license is associated with a specific geoposition which may be distinct from the geoposition of creator 110 or corporate, third-party source (e.g., literary agency, catalog administration company, syndicated content service, etc.).

Next, in step 410, marketplace portal 102 is capable of creating a content array 300 containing all content and content pitch proposals for review by a publisher 108. In one embodiment, such content array is in the form of a geographic map displaying content and content pitch proposals as associated with various locations on the map. In another embodiment, the content array is displayed as a sortable table with various criteria associated with each licensable content or content pitch proposal. A publisher 108 may use the information displayed to select a particular content or content pitch proposal.

In step 412, a publisher 108 may submit a licensing proposal to creator 110 and/or corporate third party. In one embodiment, publisher 108 submits the licensing proposal with complete terms and conditions internally via marketplace portal 102. In another embodiment, publisher 108 uses marketplace portal 102 to identify and select a content or content pitch proposal, and negotiates the terms and conditions of the content assignment with the selected creator offline.

In step 414, publisher 108 and creator 110—an independent creator or corporate third party—agree to and enter into a licensing arrangement. In an embodiment, marketplace portal 102 additionally includes functionality to process and track delivery of licensed content, updates and edits to the licensed content. Marketplace portal 102 may additionally facilitate payments to creators 110 as consideration per the terms of the license arrangement, as well as track monies owed to, and earned by, creators 110.

Process 400, which facilitates publishers' identifying and selecting content or content pitch proposals based on their geoposition on marketplace portal 102, then terminates as indicated by step 416.

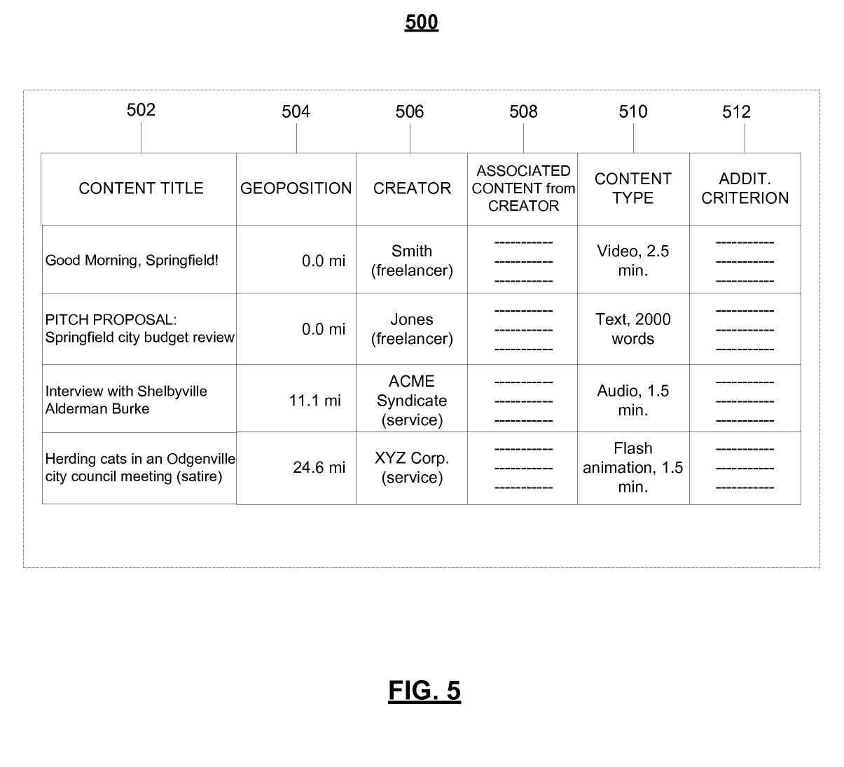

Referring to FIG. 5, a depiction of a content array 500 generated by marketplace portal 102 based on a search query submitted by a publisher 108, according to an embodiment of the present disclosure, is shown. In such an embodiment, content array 500 displays a first column 502 comprised of links to various content and content pitch proposals. Second column 504 displays the relative geoposition tagged to each content or content pitch proposal based on their distance from a location specified by publisher 108.

A third column 506 displays the creator 110 of each content and content pitch proposal. A fourth column 508 displays links to associated content from each creator. In another embodiment, marketplace portal 102 may define association between content in various ways, including tagged geopositional data, keyword comparison, date of embodiment creation, content type, subject matter, and other means.

In an embodiment, a fifth column 510 displays content type. Publishers 108 may limit search results to reveal audio, video, text, or other specific types of content. In another embodiment, marketplace portal 102 may filter search results based on other tagged content types, including broad subject matter classifications and content style. Content array 500 may be expanded to include one or more additional columns 512, each displaying additional criterion relevant to identifying and selecting content and content pitch proposals for license.

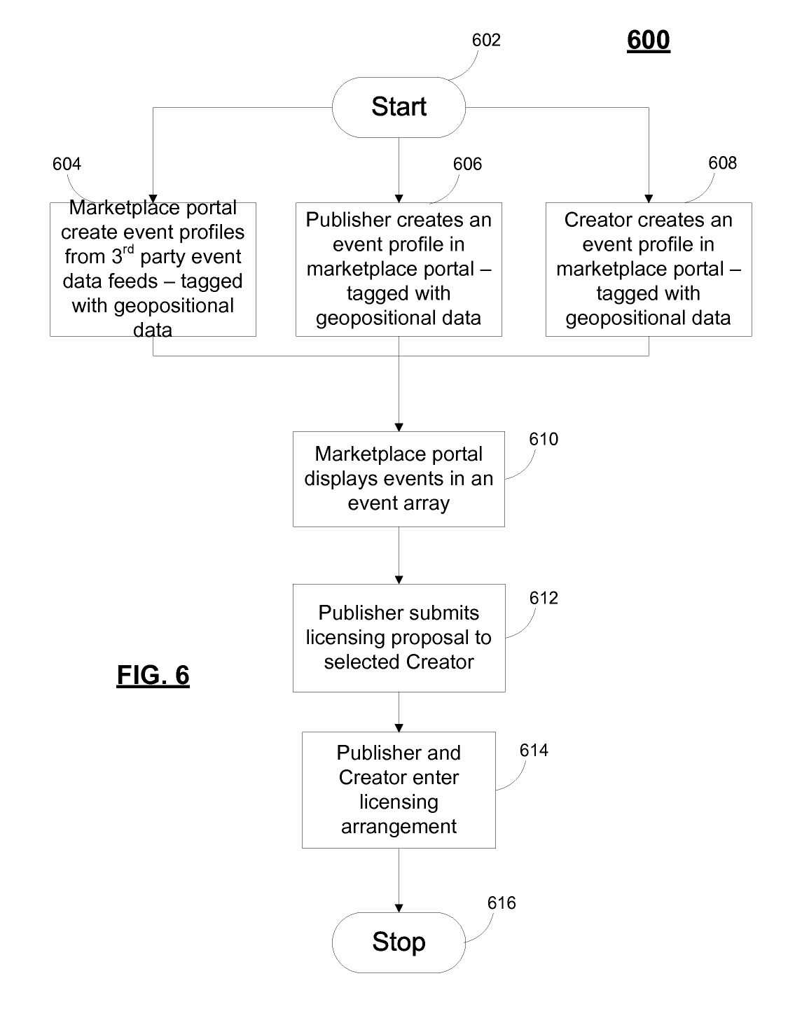

Referring now to FIG. 6, a flow chart illustrating a process by which publishers 108 may use the geoposition of various events for which content is desired as a means for identifying and partnering with content creators 110 according to an embodiment of the present disclosure is shown. Marketplace portal 102 generates a list of event profiles associated with both scheduled events and breaking news events about which publishers 108 may seek to license content. Process 600, which would execute within environment 100, begins at step 602 with control passing immediately to steps 604-608.

In step 604, marketplace portal 102 may create event profiles based on data from third-party event data feeds. In such an embodiment, marketplace portal 102 may use Real Simple Syndication (RSS) feeds from sports arenas, concert halls, convention centers, and other venues to generate event profiles based on scheduled events taking place at each venue. In step 606, a publisher 108 may proactively create an event profile for an event they would like to license associated content. In step 608, creators 110 may proactively create an event profile for an event they would like to make associated content available for license. In such an embodiment, event profiles may include geopositional data. Creators 110 may associate tagged content and content pitch proposals with specific event profiles.

Next, in step 610, marketplace portal 102 creates an event array for display to publishers' computing devices. The event array includes all content and content pitch proposals for review by publishers 108. In such an embodiment, this event array is in the form of a geographic map displaying various events in various locations on the map. In another embodiment, the event array is displayed as a sortable table with various criteria associated with each event profile. A publisher 108 may use the information displayed to select a particular content or content pitch proposal associated with a particular event profile.

In step 612, a publisher 108 may submit a licensing proposal to a creator 110 with content or a content pitch proposal associated with a desired event profile. In such an embodiment, publisher 108 submits the licensing proposal with complete terms and conditions via marketplace portal 102. In another embodiment, publisher 108 uses marketplace portal 102 to identify and select a content or content pitch proposals, and then negotiates the terms and conditions of the content assignment with the selected creator 110 in an offline manner.

In step 614, publisher 108 and creator agree to enter into a licensing arrangement. In such an embodiment, marketplace portal 102 also includes functionality to process and track delivery of the licensed content, updates and edits to the licensed content, and payments to creator 110 as consideration.

Process 600, which facilitates publishers using the geoposition of various events for which content is desired as a means for identifying and partnering with content creators on marketplace portal 102, then terminates as indicated by step 616.

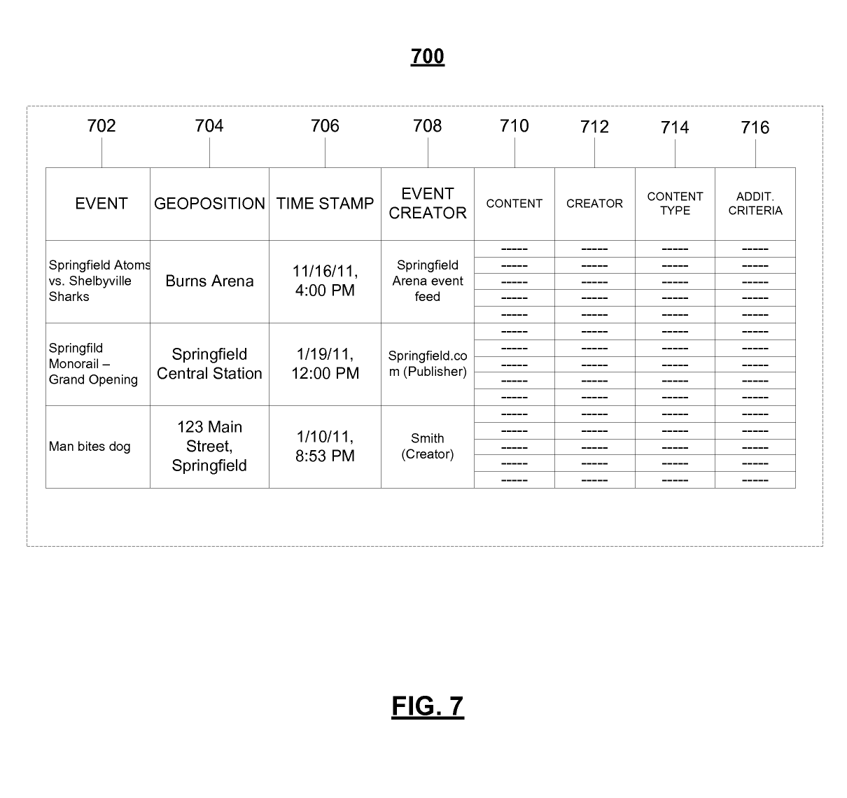

Referring to FIG. 7, an event array 700 generated by marketplace portal 102 allowing publishers 108 to view licensable content and content pitch proposals sorted accorded to their association with scheduled and breaking news events, according to an embodiment of the present disclosure, is shown. In such an embodiment, event array 700 is generated by marketplace portal 102 based on a search query submitted by a publisher 108. In such an embodiment, event array 700 displays a first column 702 comprised of links to various event profiles. A second column 704 displays the geoposition tagged to each event profile. In one embodiment, geoposition is displayed based on known landmarks. In another embodiment, geoposition is displayed using other familiar location indicators.

A third column 706 displays a time stamp associated with each event profile. Publishers 108 sorting by this column may identify breaking news events by the time stamp. A fourth column 708 identifies the source of the event profile, be it a third-party event data feed, a publisher 108, or a creator 110. A fifth column 710 displays licensable content and/or content pitch proposals associated with each event profile. A sixth column 712 displays the creator 110 for each licensable content or content pitch proposal. A seventh column 714 displays content type. Event array 700 may also be expanded to include one or more additional columns 716, each displaying additional criterion.

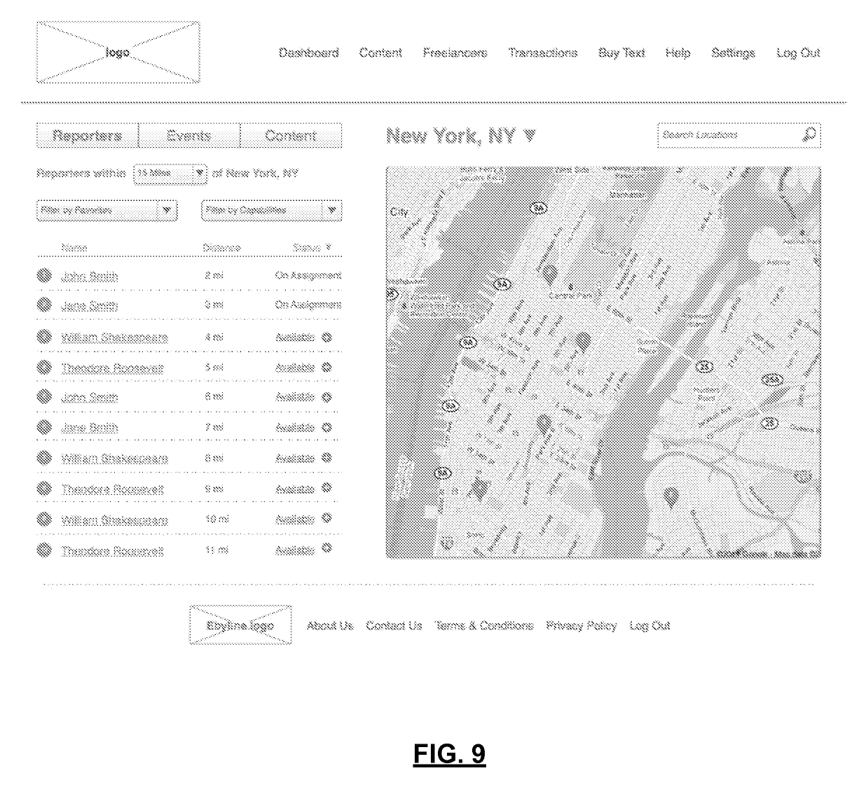

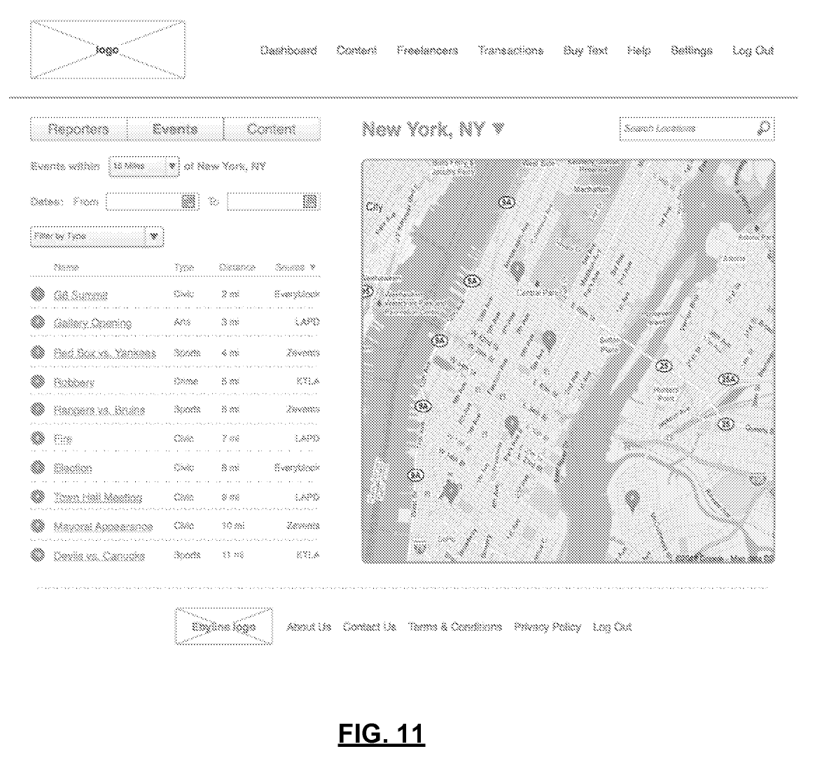

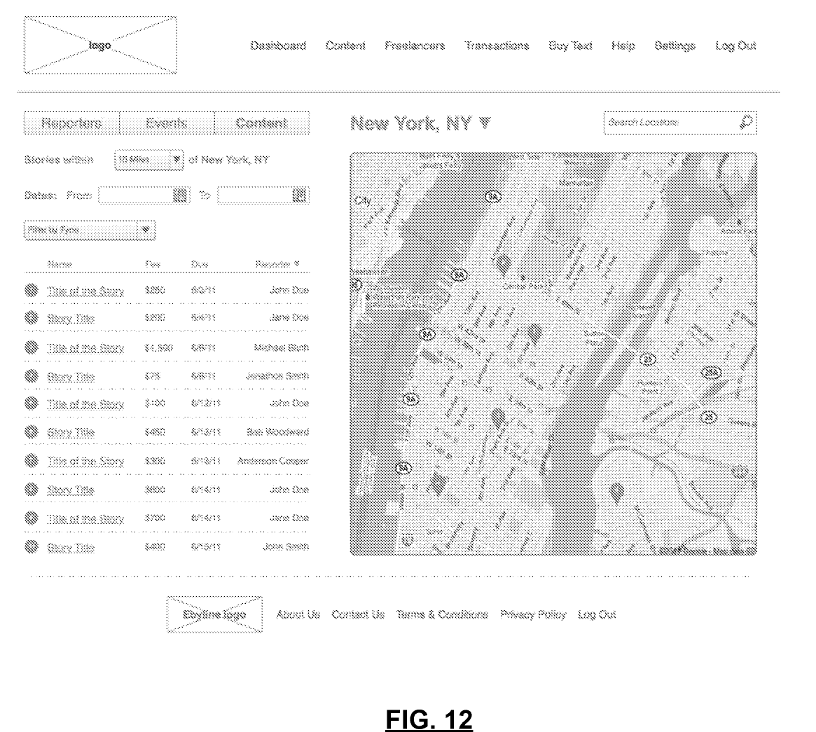

In an embodiment of the present disclosure, a publisher (or editor) 108 may assign work or add freelancers 110 to a list of “favorites” within their user account. This allows an editor to locate and/or display freelance 110 journalists within marketplace portal 102 on a map GUI. In such an embodiment, editors 108 may see their favorite and non-favorite freelancers 110 on a map based on such freelancers' 110 address—without actually displaying freelancers' 110 actual address—and may see such freelancers 110 on a map based on actual location transmitted by a mobile device (should freelancer allow location service). FIG. 9 depicts a GUI displaying freelancer 110 locations, filtered by favorites according to an embodiment of the present disclosure. In such an embodiment, editors 108 may select a radius or location, and see their favorite and other freelancers within that radius. Specified information may be visible (e.g., name, contact information, city, state, and country), however specific home address may not be visible. An editor 108 may zoom in; however there may be a limit on the zooming capability set by a system administrator. An editor 108 may additionally view content creator types (e.g., writer, photographer, videographer, etc.). Such an embodiment is depicted the GUI screen depicted in FIG. 11, where freelancers 110 are sorted by location type and source. In addition, FIG. 12 depicts editors 108 GUI screen with freelancer 110 locations are sorted by type and reporter according to an embodiment of the present disclosure.

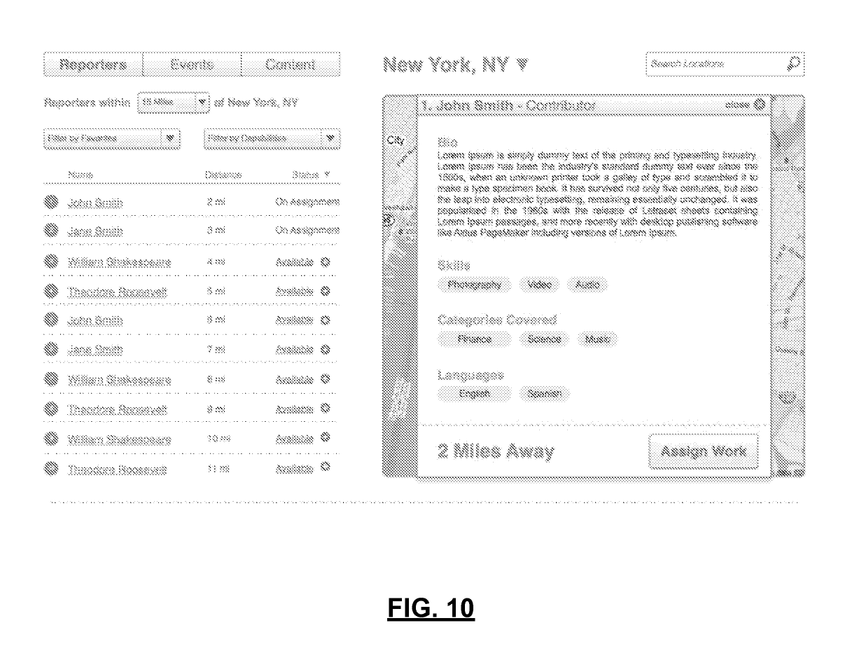

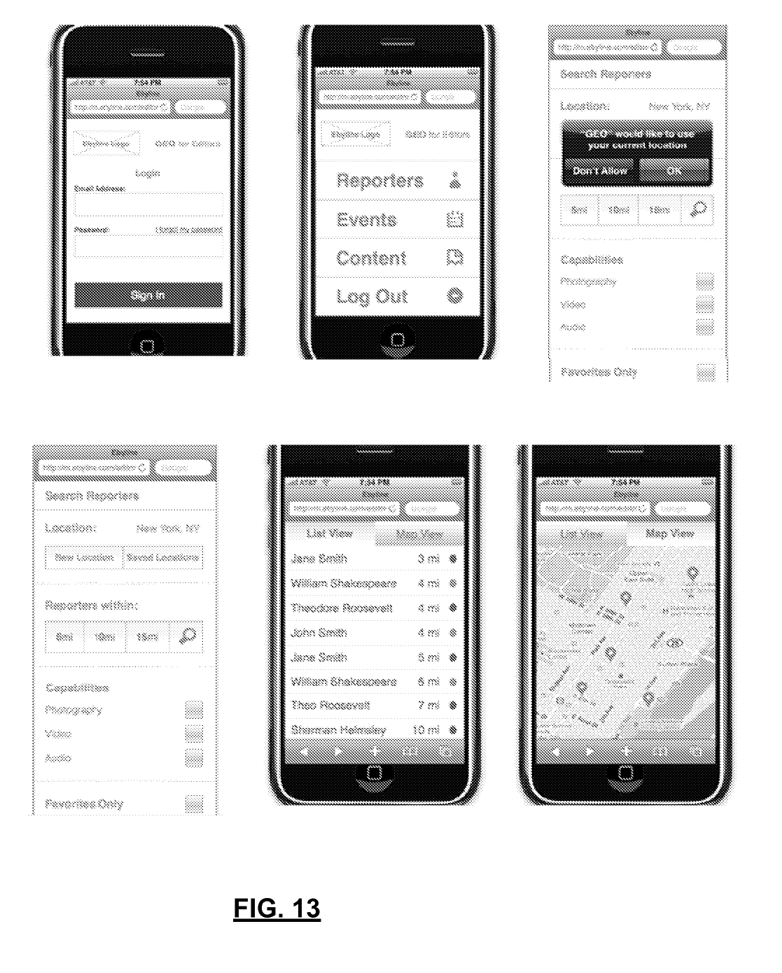

In an embodiment, an editor 108 may link to available freelancer projects, see expanded freelancer 110 profiles, search for freelancers 110 by name, and add current in-house staffers in addition to freelancers 110, all within the map interface described above. For example, FIG. 10 depicts a GUI screen with expanded freelancer 110 profiles according to an embodiment of the present disclosure. In alternative embodiments, editors 108 may search the map using a series of set parameters including category or a keyword found within a freelancer 110 biography, location—static address or GPS geoposition—proximity to a manually-entered location, and use of scrubber and comparative input parameters. Such embodiments are depicted in the mobile application GUI screens depicted in FIG. 13.

In an embodiment, editors 108 may receive content pitches from freelance journalists 110. The map interface allows editors to be alerted to content solicitations from freelancers 110. This allows editors 108 to quickly respond to content solicitations using the map interface, conduct purchase negotiations and completion of agreements to produce work (e.g., pricing, editorial details, expenses, etc.), and see pitches from all relevant locations (i.e., if from a foreign country, marketplace portal 102 would alert the editor 108 of the need to view outside their standard area).

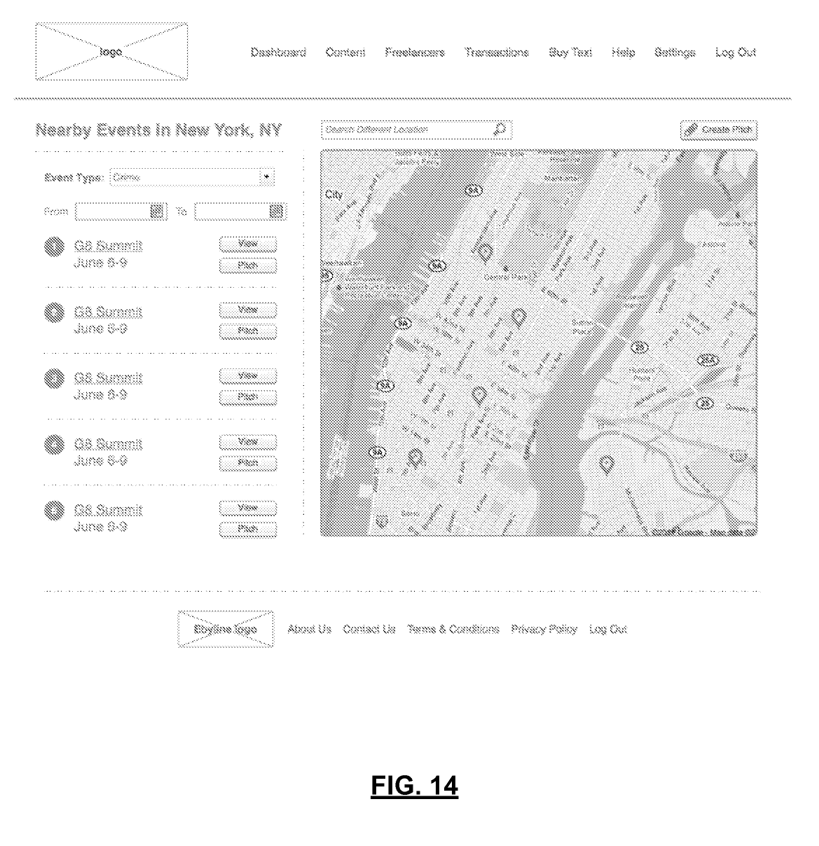

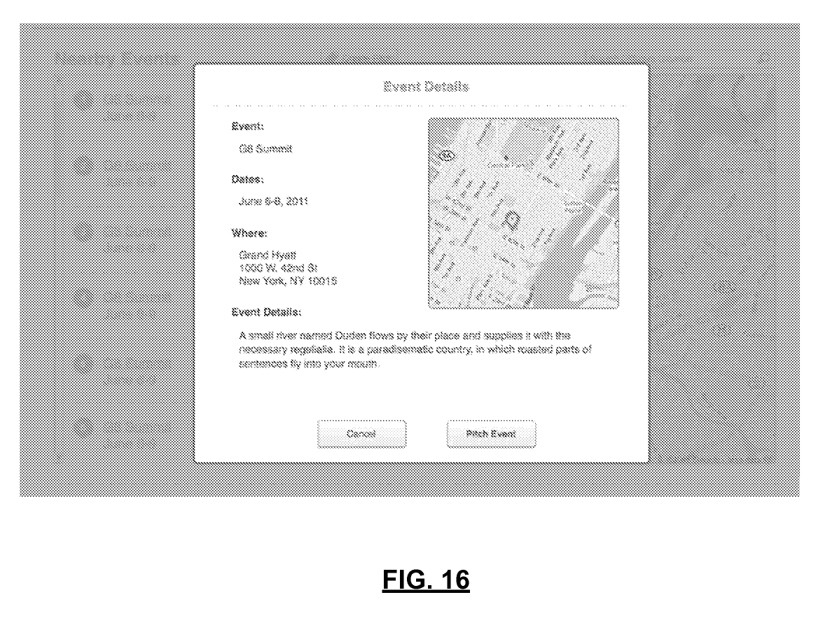

In another embodiment, editors 108 may license content from a content distributor based on the location on a map. In such an embodiment, the editor 108 may review all relevant information about a content provider and the content available (e.g., type—text, audio, video, etc.—author, and links to more information about the author or source) and make the content available to license such that editors 108 may create an assignment or event and indicate that such content available for license to other users of marketplace portal 102. Freelancers 110 may view and select such available content as depicted in the GUI screens of FIGS. 14 and 16 according to an embodiment of the present disclosure.

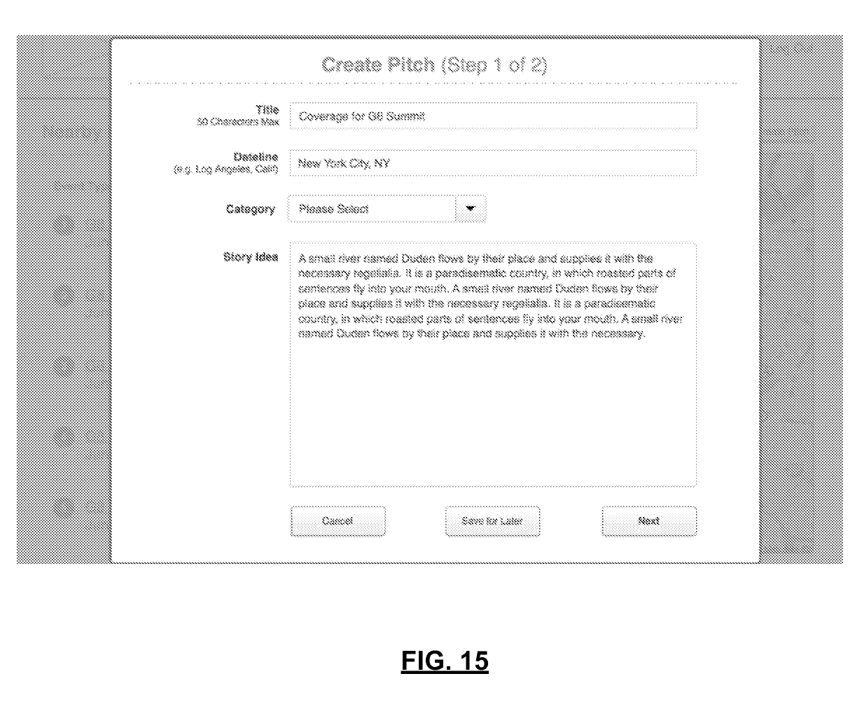

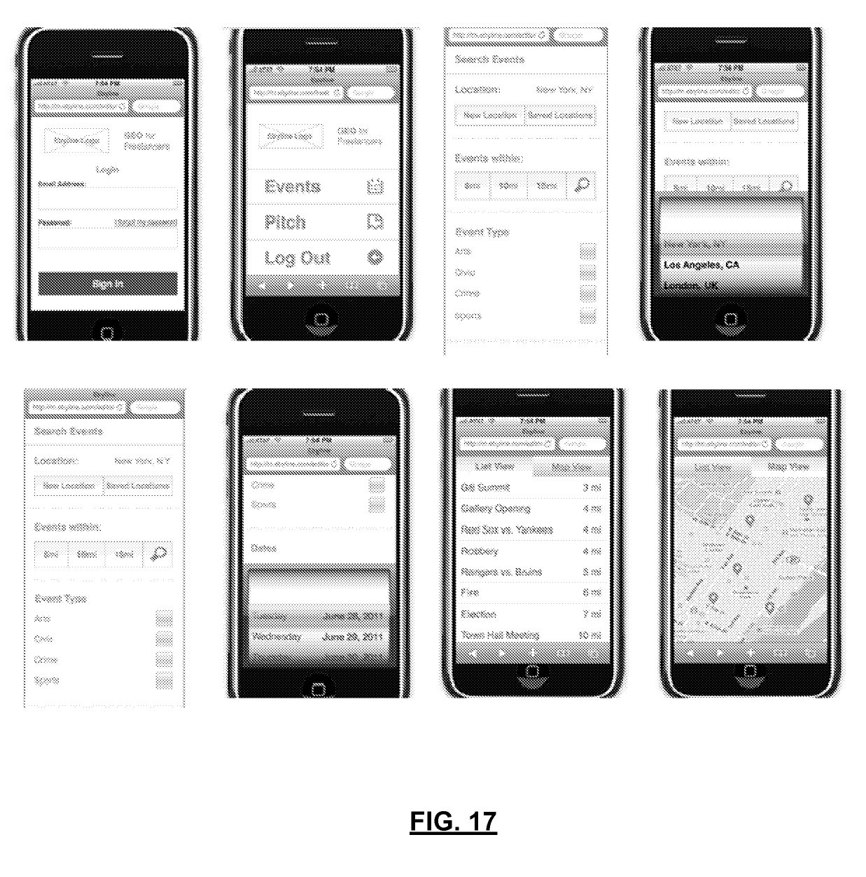

In yet another embodiment, freelancers 110 may interact with or input information to the map interface and/or geolocation service by sending their data to an editor 108. For example, FIG. 15 depicts a GUI screen where freelancers 100 may input information in response to a selected pitch, according to an embodiment of the present disclosure. Static profile data may be used to populate the editor's 108 map (including home address, etc.), and the map becomes informed with the mobile location and other mobile information of the freelancer 108. Freelancers 110 may then submit venue and/or address information for a pitch they are covering, at which point they may provide address information for projects they submit (e.g., venue, address, city, and state). In an alternate embodiment, freelancers 108 may have a map interface on which to view upcoming events and assignments, and make pitches, respond to pitches, etc. A freelancer 110 may then view upcoming events or other breaking news events as published by an editor 108. Such embodiments are depicted in the mobile application GUI screens of FIG. 17.

In another embodiment, an editor 108 may track a project (i.e., a set of pitches and assignments) and freelancer 110 locations on the map interface. In such an embodiment, an editor may see assignments from their publication and pitches that are accessible to them. From the map interface, an editor may then view pitch details and decide to accept, counter, or decline. Editors 108 may also see pitched articles and published articles geographically, allowing them to sort by favorite and non-favorite freelancers. In such an embodiment, pitches may be sorted by all publishers 108 and are exclusive to their publication. Pitches may then be sorted by date where clicking on a pitch takes the editor to a negotiation screen and clicking on a project takes the editor to a purchase screen.

In yet another embodiment, marketplace portal 102 displays the reputation rank of freelance journalists and other content creators 110. In addition to location and other profile data, editor 108 may view or filter using reputation or other ranking data.

In an embodiment, editor 108 has the ability to view the data on a map interface based on past calendar dates. Editors 108 may view dates based on the number of stories generated or produced from a location, the number of pitches made to a location, or the number of pitches from a location.

In an embodiment, freelancers 110 may load future plans and locations. In such an embodiment, as editors 108 “dial” the map calendar into the future, they may see if specific freelancers 110 will be in locations or at events that may be useful for an assignment. Incoming data on known events may also be viewed if the editor 108 dials the map calendar into the future for the purpose of assigning freelancers 110 to cover known future events. Also, the layover of relevant future events and freelancer 110 locations is possible (i.e., a conference in New York shows as running for one week in the next month, and the presence of six freelancers 110 in New York at that time next month is laid over the event).

In another embodiment, the map interface may generate traffic based on the source (author or organization) and display information to show how much traffic a freelancer 110 generated. In such an embodiment, editor 108 may go to an Internet search engine and enter any search term relevant to specific research for a story. When the user clicks “Maps” in the search engine results, whatever is outputted may be ingested by or interfaces with a geo search on marketplace portal 102 in order to compare general maps search results with the location of reporters or other relevant data points on the map interface.

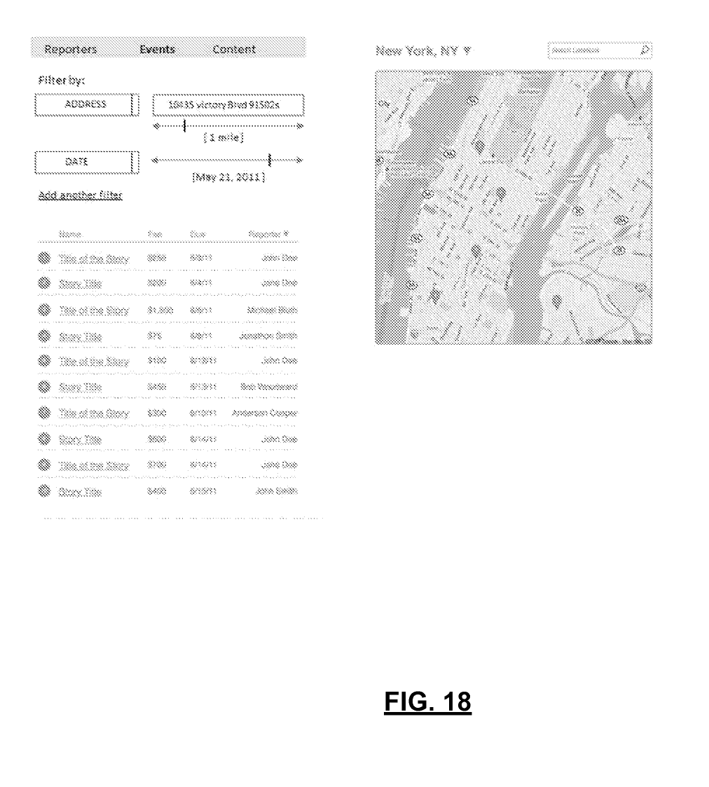

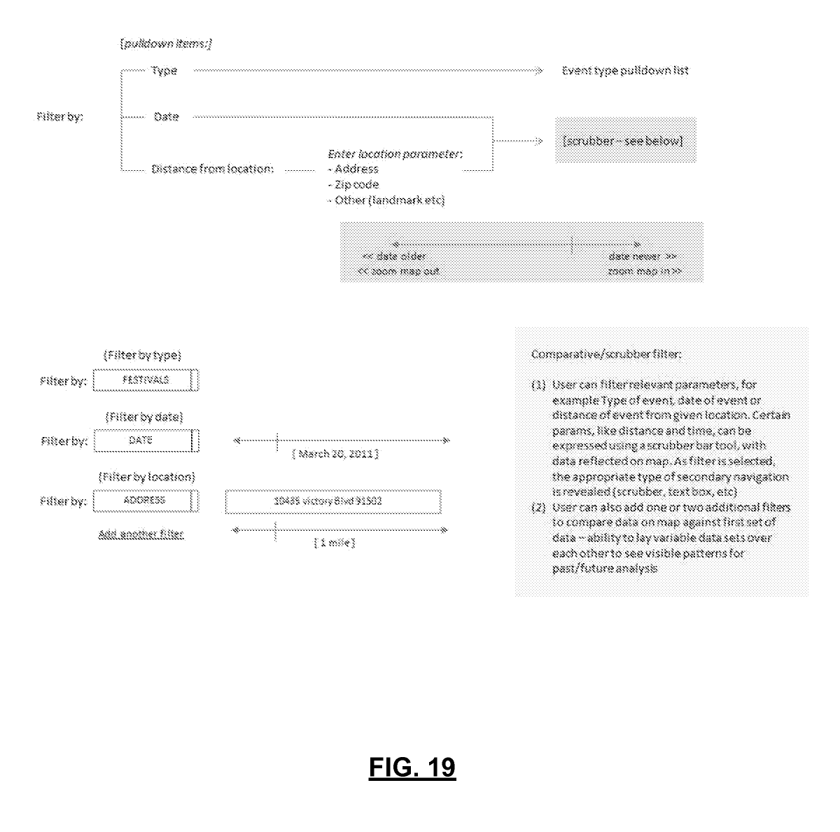

In another embodiment, the user has the ability to display public information from a commercial information provider (e.g., the PR Newswire service available from PR Newswire Association LLC of New York, N.Y.). In such an embodiment, the user has the ability to see and compare metrics against one another on a map (e.g., comparing geography against skill). The user may also have the ability to view past story performance or data. Such a display includes information about creator type, date of creation, content type, media type, and other relevant data. In various embodiments, the user may choose the data inflow source to lay over reporter geoposition, crime or public incident reports, event listings, and comparative filter tools. Such embodiments are depicted in the GUI screens of FIGS. 18-19.

In another embodiment, a publisher 108 user may sign in and be located by marketplace portal 102. Such user may then search and locate currently favorite freelancers 110, filter freelancers 110 by capability, and view, assign, and manage projects. In such an embodiment, the user is shown on a map or other display with state and/or condition indicated by the user's mobile application. Editors 108 may then engage with mobile creator users 110 in certain proscribed ways, including but not limited to a fast query (are you available?) and proper story pitch (query about commissioning a story).

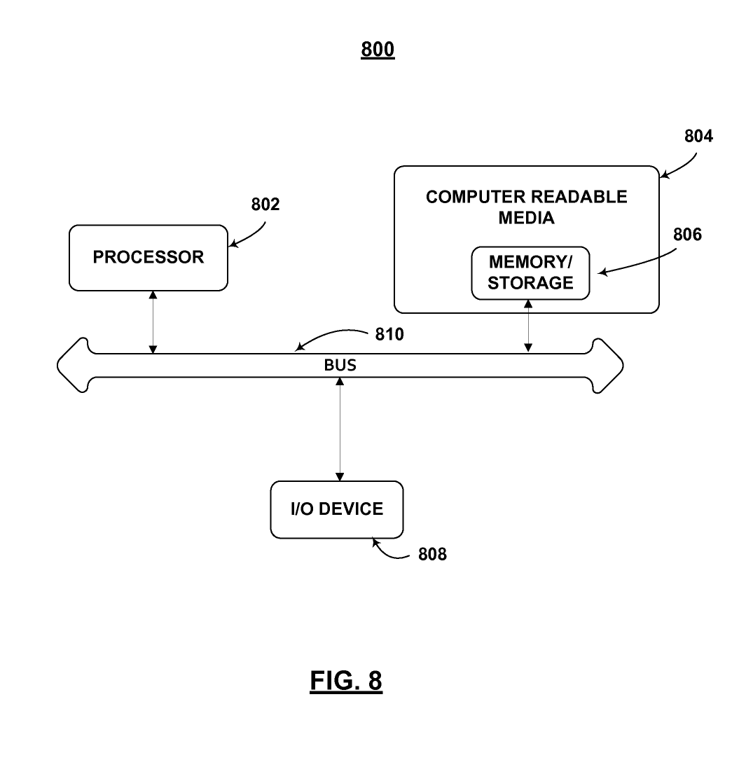

Referring now to FIG. 8, a block diagram of an example computing device 800 that may be configured to implement various aspects of the online marketplace portal for content creation and licensing using geopositional data, in accordance with one or more embodiments of the present disclosure, is shown. In various embodiments, computing device 800 implements server 104, the devices utilized by users 108-110 to access portal 102, or any other (online content licensing marketplace portal) component of environment 100.

Computing device 800 includes one or more processors or processing units 802, one or more computer readable media 804 which may include one or more memory and/or storage components 806, one or more input/output (I/O) devices 808, and a bus 810 that allows the various components and devices to communicate with one another. Computer readable media 804 and/or one or more I/O devices 808 may be included as part of, or alternatively may be coupled to, computing device 800. Bus 810 represents one or more of several types of bus structures, including a memory bus or memory controller, a peripheral bus, an accelerated graphics port, a processor or local bus, and so forth using a variety of different bus architectures. Bus 810 may include wired and/or wireless buses.

Memory/storage component 806 represents one or more computer storage media. Component 806 may include volatile media (such as random access memory (RAM)) and/or nonvolatile media (such as read only memory (ROM), Flash memory, optical disks, magnetic disks, and so forth). Component 806 may include fixed media (e.g., RAM, ROM, a fixed hard drive, etc.) as well as removable media (e.g., a Flash memory drive, a removable hard drive, an optical disk, and so forth).

The techniques discussed herein may be implemented in software, with instructions being executed by one or more processing units 802. It is to be appreciated that different instructions may be stored in different components of computing device 800, such as in a processing unit 802, in various cache memories of a processing unit 802, in other cache memories of device 800 (not shown), on other computer readable media, and so forth. Additionally, it is to be appreciated that the location where instructions are stored in computing device 800 may change over time.

One or more input/output devices 808 allow a user to enter commands and information to computing device 800, and also allow information to be presented to the user and/or other components or devices. Examples of input devices include a keyboard, a cursor control device (e.g., a mouse), a microphone, a scanner, and so forth. Examples of output devices include a display device (e.g., a monitor or projector), speakers, a printer, a network card, and so forth.

Various techniques may be described herein in the general context of software or program modules. Generally, software includes routines, programs, objects, components, data structures, and so forth that perform particular tasks or implement particular abstract data types. An implementation of these modules and techniques may be stored on or transmitted across some form of computer readable media. Computer readable media may be any available medium or media that may be accessed by a computing device. By way of example, and not limitation, computer readable media may comprise “computer storage media” and “communications media.”

“Computer storage media” include volatile and non-volatile, removable and non-removable media implemented in any method or technology for storage of information such as computer readable instructions, data structures, program modules, or other data. Computer storage media include, but are not limited to, RAM, ROM, EEPROM, Flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by a computer.

“Communication media” typically embody computer readable instructions, data structures, program modules, or other data in a modulated data signal, such as carrier wave or other transport mechanism. Communication media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media. Combinations of any of the above are also included within the scope of computer readable media.

Generally, any of the functions or techniques described herein may be implemented using software, firmware, hardware (e.g., fixed logic circuitry, system on a chip), manual processing, or a combination of these implementations. The terms “module” and “component” as used herein generally represent software, firmware, hardware, or combinations thereof In the case of a software implementation, the module or component represents program code that performs specified tasks when executed on a processor (e.g., CPU or CPUs). The program code may be stored in one or more computer readable memory devices. The features of the present disclosure described herein are platform-independent, meaning that the techniques may be implemented on a variety of commercial computing platforms having a variety of processors.

While various aspects of the present disclosure have been described above, it should be understood that they have been presented by way of example and not limitation. It will be apparent to persons skilled in the relevant art(s) that various changes in form and detail may be made therein without departing from the spirit and scope of the present disclosure. Thus, the present disclosure should not be limited by any of the above described exemplary aspects, but should be defined only in accordance with the following claims and their equivalents.

In addition, it should be understood that the figures in the attachments, which highlight the structure, methodology, functionality and advantages of the present disclosure, are presented for example purposes only. The present disclosure is sufficiently flexible and configurable, such that it may be implemented in ways other than that shown in the accompanying figures (e.g., implementation within computing devices and environments other than those mentioned herein for illustration purposes).

Further, the purpose of the foregoing Abstract is to enable the U.S. Patent and Trademark Office and the public generally and especially the scientists, engineers and practitioners in the relevant art(s) who are not familiar with patent or legal terms or phraseology, to determine quickly from a cursory inspection the nature and essence of this technical disclosure. The Abstract is not intended to be limiting as to the scope of the present disclosure in any way.

What is claimed is:

1. A computer-implemented method for facilitating an online marketplace for the licensing of content, comprising the steps of:
(a) receiving geopositional information from a pluality of content creators;
(b) storing a plurality of content available for licensing from said plurality of content creators;
(c) receiving a search query from a publisher, said search query based at least upon geopositional information;
(d) presenting, via a graphical user interface, a creator array to said publisher in response to said search query, wherein said creator array comprises licensing information related to a subset of said plurality of content creators and a subset of said pluality of content;
(e) receiving, from said publisher, a selection of one of said subset of said plurality of content creators; and
(f) sending said selected one of said subset of said plurality of content creators a notification indicative of said publisher desiring to enter into a licensing arrangement with said selected one of said subset of said plurality of content creators relating to one of said subset of said pluality of content.

2. The method of claim 1, wherein each of said plurality of content is one of: a previously-created content; and a content pitch.

3. The method of claim 1, wherein said licensing information, contained in said creator array, comprises at least one term and condition for licensing each of said subset of said pluality of content.

4. The method of claim 1, wherein said sending step (f) comprises sending at least one of: an SMS; an MMS; an IM; a chat; a voice; and an e-mail; message to said selected one of said subset of said plurality of content creators.

5. The method of claim 1, further comprising the steps of:
(g) storing user profile information for each of said pluality of content creators;
wherein said creator array presented to said publisher further comprises said user profile information for each of said subset of said plurality of content creators.

6. The method of claim 1, further comprising the steps of:
(g) tracking at least one of: delivery; updates; and edits; to said one of said subset of said pluality of content; and
(h) facilitating payment from said publisher to said selected one of said subset of said plurality of content creators.

7. The method of claim 1, wherein each of said plurality of content creators is one of: an individual freelancer; a syndicated content service; and a literary agency.

8. The method of claim 1, wherein each of said plurality of content comprises at least one of: a written article; a photograph; a creative art piece; an audio file; a multimedia file; and a video file.

9. The method of claim 1, further comprising the step of:
(g) tagging each of said plurality of content with geopositional data; wherein said content array presented to said publisher further comprises said geopositional data for each of said subset of said plurality of content.

10. The method of claim 1, wherein said content array is presented to said publisher, via said graphical user interface, in one of the following formats: a geographic map; and a sortable table.

11. The method of claim 1, further comprising the steps of:
(g) creating a plurality of event profiles from a third-party event data feed;
(h) tagging each of said event profiles with geopositional data; and
(f) associating at least one of said plurality of event profiles with at least one of said plurality of content;
wherein said content array presented to said publisher further comprises said at least one of said event profiles for at least one of said subset of said plurality of content.

12. One or more computer storage media having stored thereon multiple instructions that implement an online content licensing marketplace portal component by, when executed by one or more processors of a computing device, causing the one or more processors to:
(a) receive geopositional information from a pluality of content creators;
(b) store a plurality of content available for licensing from said plurality of content creators;
(c) receive a search query from a publisher, said search query based at least upon geopositional information;
(d) display a creator array to said publisher in response to said search query, wherein said creator array comprises licensing information related to a subset of said plurality of content creators and a subset of said pluality of content;
(e) receive, from said publisher, a selection of one of said subset of said plurality of content creators; and
(f) send said selected one of said subset of said plurality of content creators a notification indicative of said publisher desiring to enter into a licensing arrangement with said selected one of said subset of said plurality of content creators relating to one of said subset of said pluality of content.

13. One or more computer storage media as recited in claim 12, wherein each of said plurality of content is one of: a previously-created content; and a content pitch.

14. One or more computer storage media as recited in claim 12, wherein said licensing information, contained in said creator array, comprises at least one term and condition for licensing each of said subset of said pluality of content.

15. One or more computer storage media as recited in claim 12, wherein the multiple instructions further cause the one or more processors to send at least one of: an SMS; an MMS; an IM; a chat; a voice; and an e-mail; message to said selected one of said subset of said plurality of content creators.

16. One or more computer storage media as recited in claim 12, wherein the multiple instructions further cause the one or more processors to:
(g) store user profile information for each of said pluality of content creators;
wherein said creator array presented to said publisher further comprises said user profile information for each of said subset of said plurality of content creators.

17. One or more computer storage media as recited in claim 12, wherein the multiple instructions further cause the one or more processors to:
(g) track at least one of: delivery; updates; and edits; to said one of said subset of said pluality of content; and
(h) facilitate payment from said publisher to said selected one of said subset of said plurality of content creators.

18. One or more computer storage media as recited in claim 12, wherein each of said plurality of content creators is one of: an individual freelancer; a syndicated content service; and a literary agency.

19. One or more computer storage media as recited in claim 12, wherein the multiple instructions further cause the one or more processors to:
(g) tag each of said plurality of content with geopositional data; wherein said content array presented to said publisher further comprises said geopositional data for each of said subset of said plurality of content.

20. One or more computer storage media as recited in claim 12, wherein the multiple instructions further cause the one or more processors to:
(g) create a plurality of event profiles from a third-party event data feed;
(h) tag each of said event profiles with geopositional data; and
(f) associate at least one of said plurality of event profiles with at least one of said plurality of content;
wherein said content array presented to said publisher further comprises said at least one of said event profiles for at least one of said subset of said plurality of content.
